(19) United States
(12) Patent Application Publication
(10) Pub. No.: US 2008/0005177 A1
(43) Pub. Date: Jan. 3, 2008

(54) METHOD FOR DATA CONFIGURATION AND PROVISION, FOR AGRICULTURAL WORKING MACHINES IN PARTICULAR

(76) Inventors: Thilo Steckel, Guetersloh (DE); Heinz-Hermann Wippersteg, Buende (DE); Hans-Peter Grothaus, Bielefeld (DE)

Correspondence Address: Striker, Striker & Stenby, 103 East Neck Road, Huntington, NY, 11743, US

(21) Appl. No.: 11/768,307

(22) Filed: Jun. 26, 2007

(30) Foreign Application Priority Data
Jul. 3, 2006 (DE) 10 2006 030 970.7

(51) Int. Cl. G06F 17/40; G06F 17/30

(52) U.S. Cl. 707/104.1

(57) ABSTRACT

In a method for data configuration and provision, and a device for implementing the method for objects, particularly agricultural working machines, an individualized data record for the particular object is assigned to the object in a higher-order data configurator. It is thereby ensured that efficient, machine-specific data provision is made possible. This has the advantage, in particular, that the information assigned to an object is now available in a process-independent manner, is not restricted to a specific application, and can be used to provide service concepts in a customer-oriented manner.

### CROSS-REFERENCE TO A RELATED APPLICATION

The invention described and claimed hereinbelow is also described in German Patent Application DE 10 2006 030 970.7 filed on Jul. 3, 2006. This German Patent Application, whose subject matter is incorporated here by reference, provides the basis for a claim of priority of invention under 35 U.S.C. 119(a)-(d).

### BACKGROUND OF THE INVENTION

The present invention relates to a method for data configuration and provision, and a device for implementing the method.

A large amount of operating data, such as process data, method data, and agricultural data, are currently captured and made available manually or in a semi-automated fashion, particularly in the field of utilization of agricultural working machines. The potential of this information has not been adequately tapped, since, even though machine-specific process data are made available electronically, working instructions and performance calculations are often handled separately therefrom, i.e., verbally or in writing, or the known systems are always only used in a process chain-specific context, and not in a process-independent manner.

Publication DE 43 22 293, among others, makes known a method for the electronic management of agricultural working machines, with which a central computer unit coordinates working processes between working machines. The particular goal of the disclosed method is to provide the land manager with a tool with which he can efficiently coordinate his fleet of working machines and apply auxiliary substances in a specific manner depending on the yields determined. This reduces the costs for the auxiliary substances to be applied, since only that amount of fertilizer need now be applied to the ground, for example, that was previously removed from the ground by the amount of harvested crops recorded.

To ensure that this application of fertilizer can be carried out in a geographically highly precise manner, the yield data are recorded using satellite navigation and stored in a data base, which is then called up to apply the fertilizer. Depending on the configuration, it is possible to store this geo-referenced data in a computer unit of the particular working machine before use or to transfer it on-line to the computer unit of the agricultural working machine during use.

In an embodiment of the method, the agricultural working machine, which is configured as a combine harvester, can also transmit information directly to sowing and fertilizing machines without relying on a master computer; the sowing and fertilizing machines simultaneously work the area already harvested by the combine harvester. Given that management systems of this nature are designed exclusively to apply auxiliary substances on an as-needed basis as a function of the determined yield of harvested crops, these systems are not suited to realizing data transfer between agricultural working machines and/or stationary devices in the sense of optimizing a process chain, or for efficiently incorporating agricultural working machines into existing process chains. In addition, the generated data are always limited to a specific application, and they can only be used in a reasonable manner in this specific application, i.e., during a very specific field-working step.

Publication DE makes known a further data exchange system with which a communication system—which is usually limited with respect to time—is created between agricultural working machines in an event-controlled manner using a master computer. Communication systems of this type have the advantage that agricultural working machines are incorporated in the communication system and can be removed therefrom, depending on the process chain. While they are being incorporated in the communication system, each of the agricultural working machines can access the data available in the communication system and use it, thereby making it possible to efficiently optimize the working sequences within a process chain.

A disadvantage of a communication system designed in this manner, in particular, is that the data generation and provision is linked to a specific process chain and the agricultural working machines incorporated in it. Upstream and downstream processes, such as task assignment and accounting, task-specific incorporation into further process chains, and machine-specific, process chain-independent information such as maintenance information, are not captured using the communication system described.

### SUMMARY OF THE INVENTION

The object of the present invention, therefore, is to provide a communication system for mobile and stationary devices that avoids the disadvantages of the related art described above and that, in particular, makes machine-specific, comprehensive data provision possible.

In keeping with these objects and with others which will become apparent hereinafter, one feature of the present invention resides, briefly stated, in a method for data configuration and provision for objects, comprising the steps of obtaining an individualized data record for a particular object; and assigning the individualized data record to the object in a higher-order data configurator.

Another feature of the present invention resides, briefly stated, in a device for data configuration and provision for objects, wherein the control and evaluation unit assigns an object-specific ID address to the object, the control and evaluation unit provides data exchange with a higher-order data configurator, and the data configurator is configured to assign an individualized and editable data record to the object via the control and evaluation unit.

Given that the method for data configuration and provision is essentially structured for objects such that an individualized data record based on the particular object is assigned to the object in a higher-order data configurator, it is ensured that efficient, machine-specific data provision is made possible. This has the advantage, in particular, that the information assigned to an object is now available in a process-independent manner, is not restricted to a specific application, and can be used to provide service concepts in a customer-oriented manner.

In an advantageous embodiment of the present invention, the higher-order data configurator is the Internet, and the data record is provided in the form of an Internet web site on the Internet. This has the advantage that the information can be generated worldwide, and it can be called up by the object.

Given that the Internet web site is assigned, in an individualized manner, to the object when it is delivered by a manufacturer to a recipient of the object, the information pool is available immediately at the beginning of the life cycle of the object.

In an advantageous embodiment of the present invention, the object is designed as a mobile vehicle, particularly as an agricultural working machine, thereby making it possible to also implement the method efficiently in an agricultural application.

Given that the data record can be generated in the higher-order data configurator by an external supplier, it is ensured that the information assigned to the Internet web site is rich in content, since external suppliers are particularly capable of providing special expert knowledge that would be difficult to obtain under conventional conditions.

An advantageous refinement of the present invention results when the object includes means for automatically configuring the data records, when the means are designed as a computer-based data processing system, and when the computer-based data processing system includes at least one control and evaluation unit and an object-specific ID address. In this manner, every object can be integrated in a global data exchange system, i.e., the Internet, in an uncomplicated manner, thereby making it possible to operate every object anywhere in the world.

Given that the data record(s) is/are editable by the object and/or the external supplier, the data records enable the object to incorporate itself in a working environment and/or for the object to perform self-organization.

A method for incorporation into a working environment and/or for performing self-organization of the object that is usable in a simple, structured manner is attained when program modules are linked with the data records. In an advantageous embodiment of the present invention, the program modules can be stored and/or generated, at the least, in the control and evaluation unit assigned to the object, the data configurator, or a data storage and editing unit that can be operated by the data configurator. Great flexibility in data handling results when the program modules are stored and/or generated, at the least, in a combination of the control and evaluation unit, the data configurator, or a data storage and editing unit that can be operated by the data configurator.

In an advantageous refinement of the present invention, the object is designed as an agricultural working machine, and the data records include manufacturer information, machine information, operator information, agricultural information, networking information, and maintenance information, or a combination thereof, thereby ensuring that the data records are rich in content.

In an embodiment of the present invention, the data records can represent process chains, and the particular object can be a component in one or more process chains. This has the advantage, in particular, that the particular object can be easily integrated into any process chain.

In an advantageous refinement of the present invention, a structured format of the data records and a reliable exchange of information results when the modulation of the program modules is carried out in a universal modulation language, and when the data records are editable and can be refined in a stepwise manner via integration of further program modules.

Given that the device for implementing the method for data configuration and provision is designed such that the object includes at least one control and evaluation unit, an object-specific ID address is assignable to the object using the control and evaluation unit, the control and evaluation unit enables data exchange with a higher-order data configurator, and the data configurator assigns an individualized and editable data record to the object via the control and evaluation unit, the capability is created—using a simple design—to make data available in a machine-specific, comprehensive manner.

In a further embodiment of the present invention, the manufacturer of the object releases the ID address when the object is handed over to a recipient, thereby ensuring that an individualized information memory is assigned to the object when it is made available on the market.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a schematic flow chart of the inventive method.

FIG. 2 shows a detailed view of the inventive method, in the form of a flow chart.

FIG. 3 shows the schematic depiction of an agricultural application of the inventive method.

### DESCRIPTION OF THE PREFERRED EMBODIMENTS

The present invention is described below with reference to an agricultural application, with which inventive object 1 is designed as an agricultural working machine 2. The present invention is expressly not limited to this application, however. Instead, it can also be used in any field in which informative depictions of particular object 1 are assigned to certain objects 1, and objects 1 can access these depictions, which are not described in greater detail.

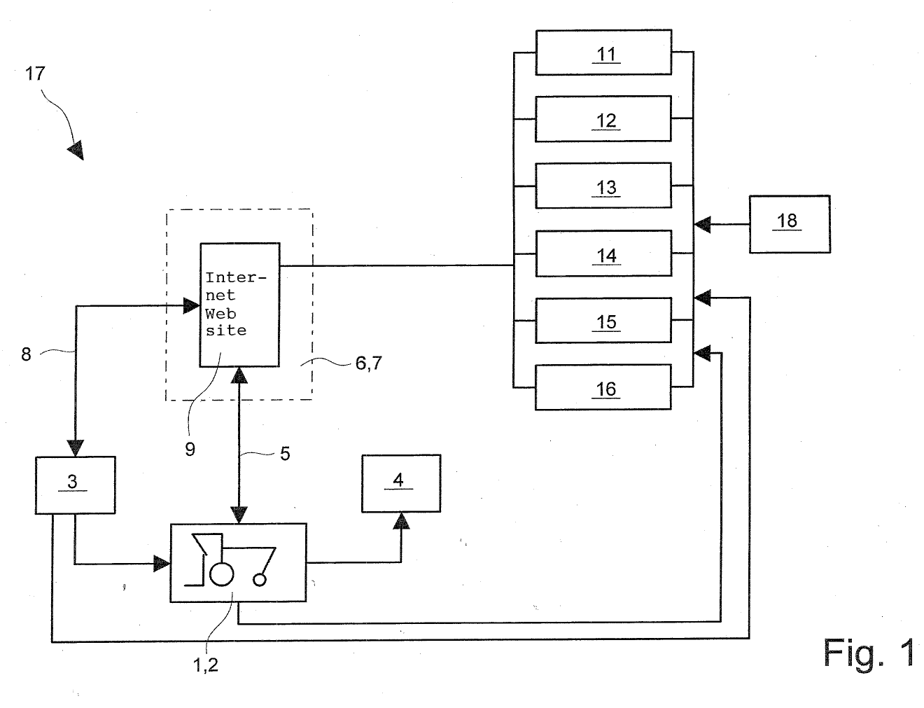

FIG. 1 shows the inventive method in the form of a flow chart. Object 1—which is agricultural working machine 2—created by manufacturer 3, is transferred after its creation to a recipient 4, either directly by manufacturer 3 or marketing organizations. Recipient 4 can be the end user, a land manager, a contractor, or an intermediary. When agricultural working machine 2 is handed over, it is set up by manufacturer 3 or authorized third parties such that they can exchange information with a higher-order data configurator 6 via a data transmission system 5 to be described in greater detail. In the exemplary embodiment shown, higher-order data configurator 6 is globally accessible Internet 7. When object 1 is handed over, manufacturer 3 has already created an Internet web site 9 in higher-order data configurator 6 using a communication system 8, which object 1 can access using data transmission system 5. Individualized data records 10 to be described in greater detail below and which are specific for object 1, which is an agricultural working machine 2 in this case, are stored on Internet web site 9.

In the example shown, the stored data records include manufacturer information 11, such as product documentation, operating instructions, and repair instructions. This information makes it possible for the operator of agricultural working machine 2 to call up machine-specific data from individualized Internet web site 9, which are independent of the incorporation of object 1 in process chains, since they are also tailored specifically to object 1 as such.

Individualized data record 10 also includes machine information 12, which can include process-dependent and process-independent information. A machine profile can be stored here, which includes machine specifications, performance parameters, technical data, software versions, and installed systems. The machine information can also include information that supports applications and processes carried out by agricultural working machine 2. The information should pertain, in particular, to whether and how to support quality management systems, automatic process data acquisition, and hauling logistics. It is also feasible that machine information 12 includes information as to whether the specific agricultural working machine 2 supports automated turnaround systems, teleprocess optimizations, and automatic steering systems and, if so, how this is carried out.

Data record 10 can also include operator information 13, which is tailored to recipient 4 who will use agricultural working machine 2, and mainly includes features of vehicle pool management, information about the vehicle fleet, and information about available business systems, such as accounting software and lease management systems.

The data record can also include agricultural information 14 in the broadest sense. Information of this type is coupled mainly to the structure of the particular process chain in which agricultural working machine 2 is incorporated. This includes, e.g., information about farm management, quality assurance, and the data required to use mapping and precision farming tools.

Data record 10 can also include networking information 15, which mainly describes the type of communication equipment provided on agricultural working machine 2, or which communication systems are available in specific regions, depending on the process chain.

Data record 10 can also include maintenance information 16 that mainly describes when and how maintenance is to be carried out, which diagnostics systems are available, and whether forecasting systems are available, and how they are used.

Due to the large amount of information that inventive data records 10 can contain, it can require a considerable amount of expert knowledge to acquire it. Inventive data configuration and provision system 17 is therefore structured such that data records 10 stored on individualized Internet web site 9 are generated by manufacturer 3, agricultural working machine 2, and external suppliers 18, or jointly by a combination thereof, and data records 10 are integrated in Internet web site 9.

In a simple application, the provision of information could be structured such that manufacturer 3 provides all manufacturer-specific information, while agricultural working machine 2 provides machine-specific and process chain-related information, such as optimized working parameter settings, quality information such as grain loss, and crop material information such as moisture content. External suppliers 18 can provide the information that requires a particular type of special knowledge and which cannot be generated by manufacturer 3 or the machine operator, or only with a great deal of effort. This would include business accounting and task administration systems, information about the vehicle pool, and, e.g., region-specific information, when a special process chain is involved.

Inventive data configuration and provision system 17 can also be configured such that individualized Internet web site 9 initially includes only a basic configuration of inventive data record 10. In the simplest case, this basic configuration is set up by manufacturer 3. Data record 10, which can be called up via individualized Internet web site 9, can now be supplemented, adapted, or subdivided further, throughout the service life of the object, thereby resulting in a data record 10 that is tailored to particular object 1 in an increasingly individualized manner.

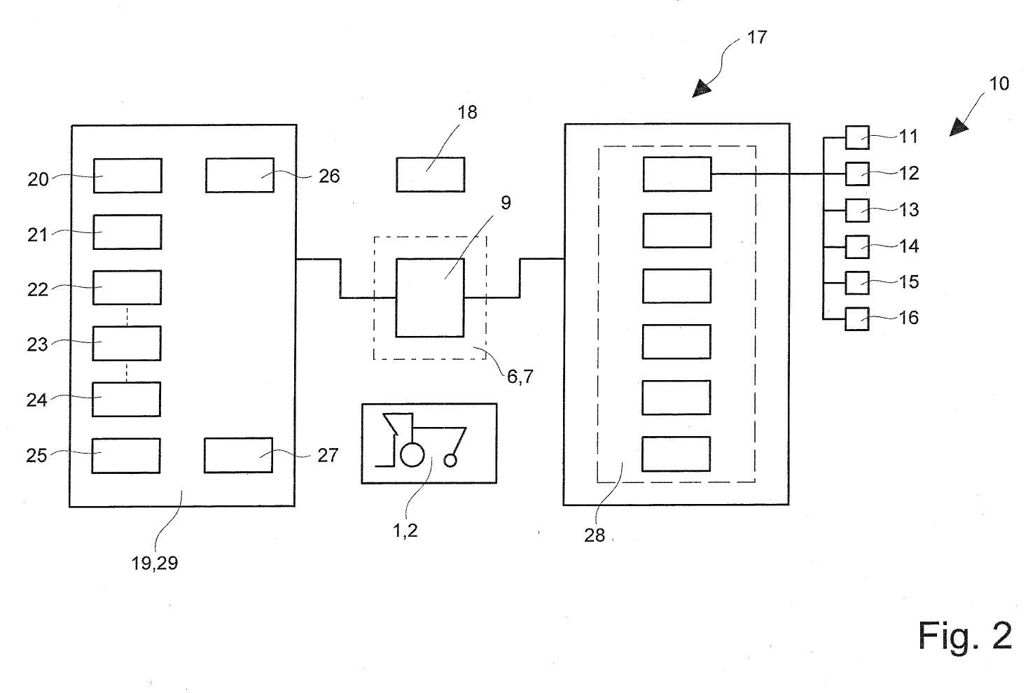

A particularly efficient data configuration and provision system 17 is depicted schematically in FIG. 2. Individualized Internet web site 9 is initially connected with a data module storage and editing unit 19, in which data modules 20 through 27—which will be described in greater detail below—are stored. In the exemplary embodiment shown, the data modules include, e.g., a task module 20, a fleet planning module 21, a grain harvest module 22, a straw press module 23, a crop material module 24, a maintenance module 25, an accounting module 26, and a repair module 27. Via data configurator 6, i.e., Internet 7 in the exemplary embodiment shown, the operator of agricultural working machine 2 and/or an external supplier 18 can generate a program module 28 tailored to particular object 1, which is designed to incorporate agricultural working machine 2 directly in a process chain, which is grain harvesting in this case.

Each of these program modules 20 through 27 can be structured in a manner similar to data record 10 shown in FIG. 1; information blocks 11 through 16 are assigned to each program module 20 through 27 or uniformly to newly generated, higher-order program module 28. Given that program modules 20 through 27 are stored in a higher-order data storage and editing unit 19, agricultural harvesting machine 2 can access the special repair program module 27 in a context-relevant manner and as needed, e.g., if damage occurs, or agricultural harvesting machine 2 can integrate itself in existing process chains defined by a higher-order program module 28. In this manner, it is possible for the agricultural working machine 2 to be enabled to automatically incorporate itself in an existing working environment; as the most practical application, this results in agricultural working machine 2 performing self-organization.

Since data storage and editing unit 19 is operated via Internet 7, it can be represented by one or more servers 29 located anywhere in the world. It would also be feasible for data storage and editing unit 19 to be located directly on agricultural working machine 2. To ensure that program modules 20 through 28 can be easily exchanged in Internet 7, program modules 20 through 28, which contain data records 10, are written in a universal modulation language known per se.

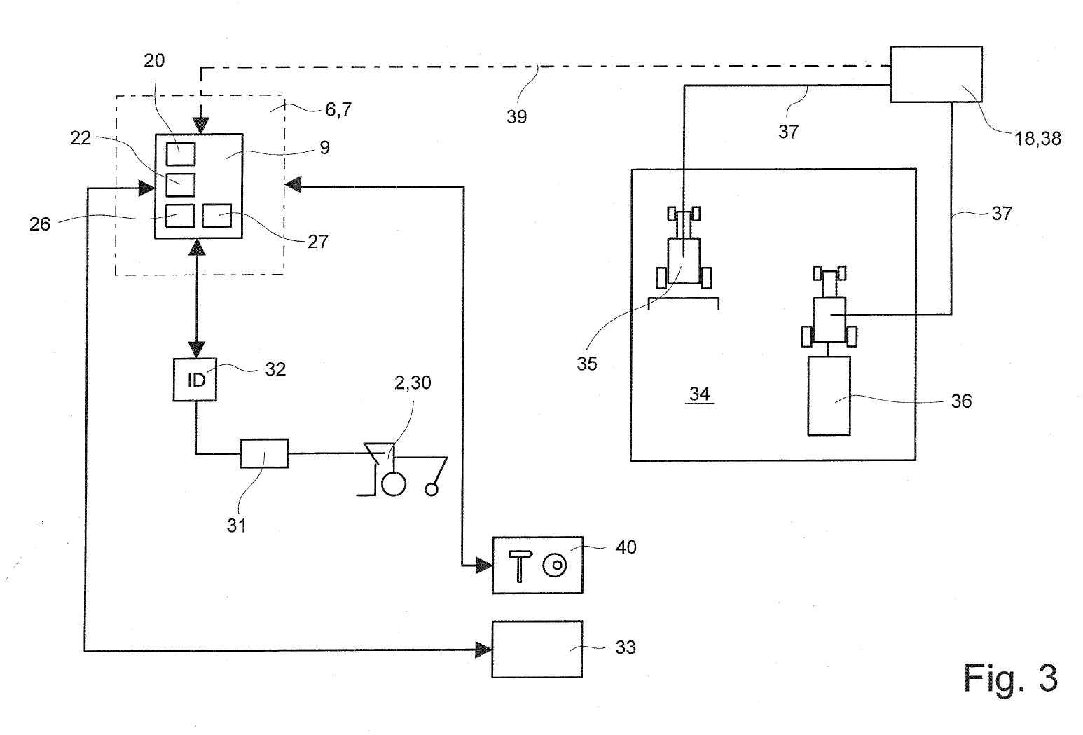

FIG. 3 illustrates the mode of operation and sequence of steps in the inventive method, based on a specific application of an agricultural working machine 2. Agricultural working machine 2 is designed as a combine harvester 30. Combine harvester 30 includes a control and evaluation unit 31, to which the manufacturer has assigned an ID address 32. Combine harvester 30 uses ID address 32 to access individualized Internet web site 9 of higher-order data configurator 6, which is designed as Internet 7. Via a vehicle pool center 33, a task module 20 was created for combine harvester 30, which combine harvester 30 can call up—in the manner described above—via Internet web site 9 assigned specifically to it. The task relates to harvesting a working territory 34, on which the “grain harvest” process chain has already begun. In the exemplary embodiment shown, a combine harvester 35 and an unloading vehicle 36 are depicted symbolically.

Combine harvester 35 and hauling vehicle 36 include data exchange systems 37—which are known per se and will therefore not be described in greater detail—via which they can exchange data with each other and with a central computer unit 38. Position data, crop material quantities, and crop material qualities are exchanged in this manner in particular. An exact picture of the current stage of the “grain harvest” process chain at a particular instant is therefore produced in central computer unit 38, particularly with regard for which areas of working territory 34 still need to be harvested. This information is transferred by computer unit 38—which serves as external supplier 18—via data transmission systems 39 known per se to Internet 7, i.e., higher-order data configurator 6.

Combine harvester 30 can incorporate this information in its individualized Internet web site 9 as grain harvest program module 22. It would also be feasible for this incorporation to be carried out directly by external computer unit 38. Vehicle pool center 33 can also simultaneously assign an accounting program module 26 to combine harvester 30, thereby making it possible for the services performed by combine harvester 30 to be accounted for immediately. Program modules 20, 22, 26 mentioned as examples form higher-order program module 28, which contains inventive data records 10.

Selected program modules 20, 22, 26 now contain all of the information that guides combine harvester 30 to territory 34 to be worked, enables combine harvester 30 to be incorporated in the process chain that is underway, enables the machine parameters to be optimized in terms of producing a high-quality crop product and to utilize the machine efficiently, and ultimately ensures that the invoicing to the owner of territory 34 that has been worked is accomplished easily. If damage occurs to combine harvester 30 while it is being used, combine harvester 30 activates—via its individualized Internet web site 9 and using its assigned ID address—a repair program module 27 that provides him with on-line help to perform the repair work.

It would also be feasible for the activation of repair program module 27 to incorporate a repair shop 40 in the repair process directly using suitable data exchange systems 39, e.g., by requesting repair work, in the simplest case. It is within the scope of the present invention for repair shop 40 itself to provide repair program module 27. A similar procedure can be provided when maintenance work is to be performed on combine harvester 30, and combine harvester 30 activates a maintenance program module 25 via its individualized Internet web site 9. Activated program module 25 also includes all information required by the operator of combine harvester 30 in this case.

One skilled in the technical art is capable of transforming the method described in a manner not described, or to use it in applications other than those depicted here, to obtain the effects described, without leaving the scope of the present invention.

It will be understood that each of the elements described above, or two or more together, may also find a useful application in other types of constructions and methods differing from the type described above.

While the invention has been illustrated and described as embodied in a method for data configuration and provision, for agricultural working machines in particular, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method for data configuration and provision for objects, comprising the steps of obtaining an individualized data record for a particular object; and assigning the individualized data record to the object in a higher-order data configurator.

2. A method as defined in claim 1, further comprising providing the higher-order data configurator as an Internet; and providing the data record as an Internet web site in the Internet.

3. A method as defined in claim 2, further comprising assigning the Internet web site in an individualized manner to the object when it is delivered by a manufacturer to a recipient of the object.

4. A method as defined in claim 1, further comprising providing the object as a mobile vehicle.

5. A method as defined in claim 4, further comprising providing the mobile vehicle as an agricultural working machine.

6. A method as defined in claim 1, further comprising generating the data record in the higher-order data configurator by external suppliers.

7. A method as defined in claim 1, further including in the object, means for automatically configuring the data records.

8. A method as defined in claim 7; further comprising configuring the means as a computer-based data processing system.

9. A method as defined in claim 8, further comprising including in the computer-based data processing system at least one control and evaluation unit and an object-specific ID address.

10. A method as defined in claim 1, further comprising editing the data record by the object and an external supplier such that the data record enables the object to incorporate itself in a working environment and/or for the object to perform self-organization.

11. A method as defined in claim 10, further comprising accomplishing the incorporation into a working environment and/or the self-organization by linking program modules with the data record.

12. A method as defined in claim 11, further comprising storing the program modules and/or generating at least in a control and evaluation unit assigned to the object, the data configurator or a data storage and editing unit that is operatable by the data configurator.

13. A method as defined in claim 11, further comprising storing and/or generating the program modules at least in a combination of a control and evaluation unit, the data configurator, or a data storage and editing unit operated by the data configurator.

14. A method as defined in claim 1, further comprising providing the object as an agricultural working machine, and including in the data record information selected from the group consisting of manufacturer information, machine information, operator information, agricultural information, networking information, maintenance information, and a combination thereof.

15. A method as defined in claim 1, further comprising depicting by the data record process chains, and forming the object as a component in one or more process chains.

16. A method as defined in claim 15, further comprising describing a modulation of program modules, using a universal modulation language.

17. A method as defined in claim 1, further comprising editing the data record.

18. A method as defined in claim 1, further comprising forming the data record via stepwise integration of program modules.

19. A device for data configuration and provision for objects, comprising a control and evaluation unit and a data configurator configured so that the control and evaluating unit assigns an object-specific ID address to the object, the control and evaluation unit provides data exchange with the higher-order data configurator, and the data configurator is configured to assign an individualized and editable data record to an object via the control and evaluation unit.

20. A device as defined in claim 19, wherein the device is configured so that a manufacturer of the object releases the ID address when the object is handed over to a recipient.
